(19) United States
(12) Patent Application Publication
(10) Pub. No.: US 2026/0254377 A1
(43) Pub. Date: Aug. 27, 2026

(54) METHOD FOR OPERATING AN ELECTRIC MOTOR

(71) Applicant: Schaeffler Technologies AG & Co. KG, Herzogenaurach (DE)

(72) Inventors: Erhard HODRUS, Achern (DE); Christian Eberle, Buhl (DE); Alexander Rosch, Achern (DE)

(73) Assignee: Schaeffler Technologies AG & Co. KG, Herzogenaurach (DE)

(21) Appl. No.: 18/879,068

(22) PCT Filed: Jun. 14, 2023
(86) PCT No.: PCT/DE2023/100448

§ 371 Date: Dec. 26, 2024

(30) Foreign Application Priority Data
Jun. 30, 2022 (DE) 10 2022 116 290.7
Jul. 20, 2022 (DE) 10 2022 118 125.1

(51) Int. Cl. H02P 6/18; H02P 25/026

(52) U.S. Cl. CPC H02P 6/183; H02P 25/026

(57) ABSTRACT

A method for operating an electric motor having a stator and a rotor wherein injection signals in the entire speed range in which the electric motor is operated are used to estimate the rotor position and/or the speed of the electric motor.

### CROSS-REFERENCE TO RELATED APPLICATIONS

This application is the U.S. National Phase of PCT Appln. No. PCT/DE2023/100448, filed Jun. 14, 2023, which claims the benefit of German Patent Appln. No. 102022116290.7, filed Jun. 30, 2022, and German Patent Appln. No. 102022118125.1, filed on Jul. 20, 2022, the entire disclosures of which are incorporated by reference herein.

### TECHNICAL FIELD

The disclosure relates to a method for operating an electric motor.

### BACKGROUND

In permanently excited synchronous motors, it is very important how the parts through which the magnetic field flows are positioned relative to each other. This also concerns precise knowledge of the angular position of the rotating parts, since the constantly changing position of the magnets (angular position) integrated in the rotating rotor relative to the windings integrated in the stator must always be known precisely when the motor is rotating in order to control the electric motor correctly. The changing angular position of the rotor must be known precisely at all times to determine the orientation of the rotor components (e.g., the rotor magnets, which are usually designed as permanent magnets) relative to the stator components (e.g., the stator magnets, which are usually designed as electromagnets/stator windings) and to be able to adjust the control of the motor accordingly.

The control of such an electric motor is therefore achieved by applying a rotating field to the windings of the motor. Depending on the rotor position angle, the rotating field must be adjusted via a closed-loop control system. As a rule, the position of the rotor is measured using a rotor position sensor and the determined rotor position angle is transferred to the electric motor control system.

In order to save costs and installation space, however, sensorless closed-loop control systems are already known which do not require a physical rotor position sensor. Only the current sensors are used here, which are indispensable for field-oriented closed-loop control anyway. This closed-loop control concept, which is particularly common in 3-phase permanently excited synchronous machines, is based on a transformation of the 3-phase alternating variables into a two-axis coordinate system which rotates synchronously with the rotor flux of the machine. In such a coordinate system, commonly referred to as a d/q coordinate system, for example, the three phase currents of the stator winding i_u, i_v, i_w are represented by a 2-dimensional current vector with the components i_q and i_d. For an ideal sinusoidal rotor flux and ideal sinusoidal phase currents, the original alternating variables i_u, i_v, i_w are mapped to constant variables i_q, i_d as a result of the coordinate system which rotates synchronously with the rotor flux.

In the case of field-oriented current control, the voltage values or current values of the phases of the stator of the synchronous machine are transformed in a known manner to a two-dimensional coordinate system, the mutually perpendicular axes of which are usually referred to as d (“direct”) and q (“quadrature”). This coordinate system rotates relative to the stator of the synchronous machine and is stationary relative to the rotor of the synchronous machine. The transformation itself is called the Park transformation; the two-dimensional coordinate system to which it is transformed is called the Park coordinate system. The Park transformation can take place via the intermediate step of an, also known, Clarke transformation, which transforms the voltage values or current values of the phases of the stator of the synchronous machine to a two-dimensional, orthogonal coordinate system that is stationary relative to the stator.

When an electric motor is operated without sensors, as already mentioned above, the rotor position sensor, which is usually used to determine the current angle of the rotor, is omitted. For example, current sensor signals and measured or estimated phase voltages are used to infer the rotor position and speed of the motor via a model. Below a speed threshold of the absolute speed, it is necessary to feed in what are termed injection signals, which support the identification of the rotor position and the speed in this speed range.

WO 2020 001 681 A1 describes an electric motor, having a stator and a rotor which can rotate relative to the stator, and a control system, which can output a current pulse to the electric motor, wherein the current pulse causes a rotational movement of the rotor in a first direction of rotation and by a first angle of rotation and thereby causes an induced voltage which is received by the control system and by which the control system determines the direction of rotation and/or the rotational position of the rotor with respect to the stator.

DE 10 2018 120 421 A1 discloses a method for sensorless closed-loop control of permanently magnetically excited, synchronous electric motors, in which a system is described in a stationary αβ coordinate system of an electric motor. The system comprises an electromagnetic model and a mechanical model of an electric motor with a drive train. For the model, differential inductances, each of which depends on the currents of the electric motor, are stored in the form of look-up tables. The look-up tables can be retrieved for calculation. Based on the electromagnetic and mechanical model, the speed and angle of the electric motor are estimated by a Kalman filter, mainly via the mechanical model. The electrical model can be used to provide an in-ternal torque for the torque equation in order to determine a change in speed or angle.

Sensorless operation of electrical machines has not yet become established in electric vehicles. The reason for this is that sensorless operation has been proven to work well and in a stable manner at higher speeds. For speeds close to zero revolutions, operation is only possible with the addition of injection signals. However, the se-lection of suitable injection signals poses a very big challenge, since the effects of injection signals are not always positive on the system. On the one hand, the injection signals can cause unwanted noises, and on the other hand, it is difficult to find a stable and robust combination in terms of frequency and amplitude when choosing the injection signals.

However, the use of a safety-certified rotation angle sensor for the rotational angle position of the rotor also helps with the discussion of safety-critical scenarios in functional safety. For example, for pump drives, compressors or fans, sensorless operation of corresponding electrical machines is already prior art. A popular approach for starting the motor is to switch from a purely open-loop controlled start-up of the electric motor by specifying a rotating field to a sensorless closed-loop controlled electric motor. This approach avoids the use of injection signals for speeds close to zero.

The as yet unpublished German patent application DE 10 2022 102 634.5 discloses a start-up sequence of the electric motor in a P1 hybrid, starting with an open-loop controlled start-up at no speed and then switching to a sensorless start-up closed-loop controlled operation, in which the speed signal of the combustion engine is also used to check whether the desired speed has been reached.

Switching from open-loop controlled operation to sensorless closed-loop controlled operation inevitably results in strong pulses in the current or voltage signals, since the angle signal required to control the electric motor usually has a discontinuity between open-loop controlled operation and closed-loop controlled operation. During start-up, the current angle signal is assigned, for example, to a specific angular position in the rotor-fixed coordinate system, e.g., d-direction. The angular position that occurs in sensorless closed-loop controlled operation differs from this, since q-direction components are then added to the d-direction components.

When an electric motor is operated without sensors, as already mentioned above, the rotor position sensor, which is usually used to determine the current angle of the rotor, is omitted. For example, current sensor signals and measured or estimated phase voltages are used to determine the rotor position and speed of the motor via a model and/or using the anisotropy. The use of the estimated speed and rotor position in the closed-loop control of the electric motor means that the estimated variables must be determinable in a stable and robust manner at all possible operating points of the electric motor.

Below a predetermined speed threshold of the absolute speed (cf. FIG. 1, “prior art”), it is necessary to feed in so-called injection signals in order to estimate the rotor position and the speed, which make it possible to identify the rotor position and the speed in this speed range, since the sole evaluation of induced voltages on the motor does not work reliably in this range due to the decreasing signal-to-noise ratio. Specifically, this means: If the speed decreases and tends towards zero, then the terms used for the evaluation become less dominant compared to the other terms of the equation and eventually disappear.

Injection signals often have a negative impact on the acoustics of the system and may be audible as an unwanted noise, for example in the interior of a vehicle.

EP 2 144 362 B1 discloses an injection method designed for small, absolute speeds.

The as yet unpublished German patent application DE 10 2022 110 304.8 shows a method that can be used to initialize the rotor position angle even at small, absolute speeds.

The as yet unpublished German patent application DE 10 2022 112 712.5 examines the possibilities of switching between different methods.

The as yet unpublished German patent application DE 10 2022 103 221.3 describes that in the start-up phase the electric motor is operated in an open-loop controlled manner at low, absolute speeds. The open-loop controlled operation results in a target angle. Another target angle is also calculated from the sensorless closed-loop control algorithm during this start-up, but this information is not yet used for operation. By comparing both target angles it can be determined whether an angle correction is necessary or not. During start-up, the sensorless closed-loop control algorithm reliably finds the angle and speed that correspond to the real system in order to then use this information when the sensorless closed-loop control is activated.

The sensorless closed-loop control using a motor model and thus utilizing the induced voltages (injection-based method) represents a complex software product. This increased resource requirement has a negative impact on memory requirements and the required computing time and can overwhelm the available hardware.

A combination of several methods with open-loop control of the transient transitions between the methods places an even greater burden on resources. In addition, conventional model-based methods require precise model parameters of the electric motor over all relevant temperatures. Determining these parameters also re-quires a great deal of effort.

### SUMMARY

The disclosure is based on the object of reducing this resource requirement.

The object is achieved by a method having the features according to claim 1.

According to the method according to the disclosure for operating an electric motor with a stator and a rotor, injection signals are used in the entire speed range in which the electric motor can be operated to estimate the rotor position and/or the speed of the electric motor.

There is therefore parameter-independent, closed-loop control of the electric motor without rotor position sensors on the basis of an injection signal in the entire operating range.

In a preferred embodiment of the disclosure, the method is applied up to a useful voltage limit.

In a further preferred embodiment of the disclosure, there is anisotropy, i.e., Ld is not equal to Lq.

In a further preferred embodiment of the disclosure, the useful voltage results from the difference between an available intermediate circuit voltage and the voltage amplitude of the superimposed injection signal.

In a further preferred embodiment of the disclosure, a combination of the use of injection signals and field weakening is provided to achieve higher speeds above the useful voltage limit.

In a further preferred embodiment of the disclosure, a fraction of the maximum drive frequency is used as the injection frequency.

In a further preferred embodiment of the disclosure, an integer divisor of the maximum drive frequency is used as the injection frequency.

In a further preferred embodiment of the disclosure, at most 16 kHz/ 4 is used as the injection frequency.

In a further preferred embodiment of the disclosure, at least 1 kHz to 4 kHz is used as the injection frequency.

Advantages and advantageous embodiments of the disclosure are the subject matter of the following drawings and their description.

### BRIEF DESCRIPTION OF THE DRAWINGS

In the drawing, in detail:

FIG. 1 shows a comparison between the use of the previously common methods (prior art) and the method according to the disclosure.

### DETAILED DESCRIPTION

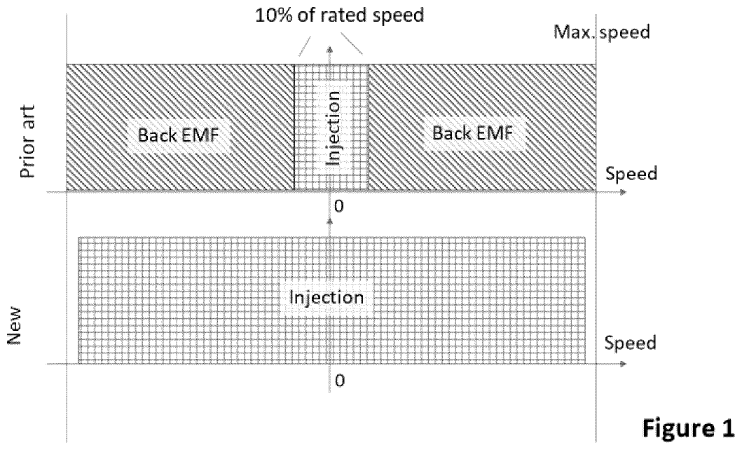

Typically, the injection-based method is only used for the operating range where the method based on induced voltages is unreliable (see FIG. 1, “prior art”). In order to reduce resources, the disclosure proposes extending the operating range of the injection-based method.

Advantages such as parameter independence and thus robustness of the injection method and low computational effort, in the case of acoustically well-damped systems, clearly outweigh the disadvantages such as unwanted noises, marginal efficiency losses and field weakening even at slightly lower speeds in the comparison system.

According to the disclosure, the injection-based method is to be used up to the useful voltage limit (cf. FIG. 1, “new”). A major advantage is the increased robustness with respect to parameter uncertainties since the method is parameter-independent. There only needs to be sufficient anisotropy, i.e., Ld must not be equal to Lq. The voltage amplitude of the superimposed injection signal must be maintained. The useful voltage can be determined from the available intermediate circuit voltage minus the amplitude. When using the injection method, the field may have to be weakened sooner than with the classic approach (prior art) in order to enable operation at higher speeds.

FIG. 1 shows the useful regions without field weakening. If higher speeds are required, the field is weakened. In the classic case this is a combination of the back EMF method (back EMF) and field weakening, and for the new approach it is a combination of the injection method and field weakening. For reasons of clarity, this is not shown in FIG. 1.

The method can be used, for example, in a hydraulic pump, since the pump, disposed in oil, has very good acoustic damping. Acoustically unwanted noises are negligible in the entire working range.

Electromagnetic compatibility of the assembly, especially at the excitation frequency of the injection signal, is provided, as is the functionality of the electric motor.

The choice of injection frequency is of crucial importance. On the one hand, a maximum drive frequency (PWM frequency), e.g., 16 kHz, is defined in the system and, on the other hand, the frequency must not be too low, so as not to induce mechanical vibrations.

In the pump example, for example, very good results can be achieved with ¼ of the PWM frequency, here e.g., 4 kHz. Function is still guaranteed at 2 kHz, but there is a stronger acoustic impairment.

A measurable impairment in efficiency cannot yet be detected for speeds greater than 10% of the rated speed.

1. A method for operating an electric motor having a stator and a rotor, the method comprising:
using injection signals in an entirety of a speed range in which the electric motor is operated to estimate at least one of the rotor position or the speed of the electric motor.

2. The method according to claim 1, wherein the method is used up to a useful voltage limit.

3. The method according to claim 1, wherein there is anisotropy, i.e., Ld is not equal to Lq.

4. The method according to claim 2, wherein the useful voltage limit results from the difference between an available intermediate circuit voltage and a voltage amplitude of the superimposed injection signal.

5. The method according to claim 2, wherein a combination of the use of injection signals and field weakening is provided to achieve higher speeds above the useful voltage limit.

6. The method according to claim 1, wherein a fraction of the maximum drive frequency is used as the injection frequency.

7. The method according to claim 1, wherein an integer divisor of the maximum drive frequency is used as the injection frequency.

8. The method according to claim 1, wherein at most 16 kHz/4 is used as an injection frequency.

9. The method according to claim 1, wherein at least 1 kHz to 4 kHz is used as the injection frequency.

10. A method for operating an electric motor having a stator and a rotor, the method comprising:
using injection signals up to a useful voltage limit in an entirety of a speed range in which the electric motor is operated to estimate at least one of the rotor position or the speed of the electric motor;
wherein there is anisotropy, i.e., Ld is not equal to Lq.;
wherein the useful voltage limit results from the difference between an available intermediate circuit voltage and a voltage amplitude of the superimposed injection signal; and
wherein a combination of the use of injection signals and field weakening is provided to achieve higher speeds above the useful voltage limit.
